(19) United States
(12) Patent Application Publication
(10) Pub. No.: US 2026/0273845 A1
(43) Pub. Date: Sep. 17, 2026

(54) HOTEND AND HEAD SET USING SAME, AND 3D PRINTING DEVICE

(71) Applicant: Shenzhen Creality 3D Technology Co., Ltd., Shenzhen (CN)

(72) Inventors: Jingke TANG, Shenzhen (CN); Qiang LI, Shenzhen (CN); Xiangming ZHOU, Shenzhen (CN); Ming YUAN, Shenzhen (CN)

(21) Appl. No.: 19/469,472

(22) PCT Filed: May 26, 2023
(86) PCT No.: PCT/CN2023/096689

§ 371 Date: Sep. 26, 2025

(51) Int. Cl. B29C 64/209; B33Y 30/00

(52) U.S. Cl. CPC B29C 64/209; B33Y 30/00

(57) ABSTRACT

The present application provides a hotend and a head set using same, and a 3D printing device. The hotend comprises a heating part, a nozzle part, a transmission channel, and a heat conduction part. The transmission channel is configured to pass through the heating part and the nozzle part, and the transmission channel has an inner wall. The heating part is used for generating or transferring heat to increase the temperature in the transmission channel. The heat conduction part is arranged in the transmission channel and is thermally coupled with the heating part, and the heat conduction part comprises protrusions protruding from the inner wall to the central axis of the transmission channel. The hotend of the present application is suitable for a high-speed printing process.

### FIELD

The present disclosure relates to field of 3D printing technology, and in particular to a hotend, a head set using the same, and a 3D printing device.

### BACKGROUND

3D printing technology is a rapid prototyping technology for manufacturing three-dimensional objects by printing materials layer by layer based on a digital model file and using special wax materials, powdered metals or plastics and other bondable materials. Fused deposition modeling (FDM) is one of the main 3D printing technologies. In this technology, a hot melt material filament is heated and melted, extruded from a nozzle, deposited on a forming platform or a previous layer of solidified material, and finally generates an object.

High-speed printing is a trend in the development of 3D printing. High-speed printing has faster printing speed, less printing time and better printing quality. However, existing hotend is more suitable for low-speed printing and medium-speed printing, the existing hotend cannot be applied to the high-speed printing process. When the nozzle suitable for low-speed printing and medium-speed printing is applied to high-speed printing, various problems, such as insufficient melting of consumables, high viscosity of consumables, far lower printing speed than expected, nozzle blockage, high printing pressure, poor molding quality and the like, often occur, so that the high-speed printing cannot be achieved as expected. Solve the above issues and provide a hotend structure that can adapt to high-speed printing is needed.

### SUMMARY

The present disclosure provides a hotend applied to 3D printing device, and a head set and a 3D printing device integrated with the hotend.

Embodiments of the disclosure provide a hotend, which includes a heating part, a nozzle part, a transmission channel and a heat conduction part. The transmission channel passes through the heating part and the nozzle part, and the transmission channel has an inner wall. The heating part is configured for generating or transferring heat to increase a temperature in the transmission channel. The heat conduction part is arranged in the transmission channel and is thermally coupled with the heating part. The heat conduction part includes protrusions, the protrusions protruding in a direction from the inner wall to a central axis of the transmission channel.

The hotend of the disclosure, the heating part is configured to generate or transfer heat to increase the temperature in the transmission channel, and consumable entering the heating part through the transmission channel is gradually melted by heat to be extruded and printed subsequently. The heat conduction part is thermally coupled with the heating part, and the contact of consumables with the heat conducting part and the conduction of heat can cause the consumables to melt. The heat conduction part protruding into the transmission channel can be in direct contact with a middle part (or a part far from the inner wall) of the consumable to conduct heat, so that the consumable is heated more uniformly and melted more sufficiently, the middle part of the consumable is prevented from being heated to a degree much lower than that of the part of the consumable in direct contact with the inner wall due to too high flow rate, viscosity of the melted consumable is reduced, printing pressure is reduced, melting speed of the consumable is increased to prevent blockage and improve forming quality. In the hotend of the application, the overall heating process of the consumable is smooth, the consumable can be uniformly heated and sufficiently melted in a short time, blockage is less likely to occur, and a lubricating layer can be further formed between the melted consumable and the inner wall, so that the hotend can be applied to a high-speed printing process and can solve various problems such as insufficient melting of the consumable, high viscosity of the consumable, printing speed much lower than expected, blockage, high printing pressure, and poor forming quality.

In an embodiment, the heat conduction part includes a first end and a second end spaced apart, the first end is connected to the inner wall, and the second end protrudes towards the central axis of the transmission channel to form the protrusions spaced apart from each other.

The second end protrudes towards a middle part of the transmission channel, so that a central part of the consumable flowing through the middle part can be directly in contact with the second end to be heated, the uniformity of melting of the consumable is improved, the consumable is melted more sufficiently, the viscosity of the consumable and the printing pressure are reduced, the sufficiently melted consumable can flow away quickly and is less likely to be blocked, and the printing speed is thus increased.

In an embodiment, the protrusions are not in contact with each other, and a first end between any two adjacent protrusions is configured to form a concave portion.

The protrusions are not in contact with each other, so that part of the transmission channel corresponding to the area where the heat conduction part located is not blocked by the heat conduction part, inner area of the transmission channel is a complete connected area, and the melted consumable can have a high flow rate when passing through the transmission channel.

In an embodiment, the protrusions are arranged in a first direction, and the first direction is an extension direction of the transmission channel; and/or a plurality of concave portions is arranged along the first direction, and the first direction is the extension direction of the transmission channel.

The protrusions and/or the concave portions are arranged along the extension direction of the transmission channel, on the one hand, the consumable is gradually heated and kept warm in the process of flowing through the transmission channel, the uniformity of melting of the consumable is improved to ensure the printing quality, and on the other hand, hindrance to the flow process of the melted consumable is minimized, and the flow rate is increased.

In an embodiment, a width of one of the protrusions in a cross section gradually decreases from the first end to the second end; and/or a width of the concave portion in a cross section gradually increases from the second end to the first end.

In an embodiment, the protrusions are arranged symmetrically with respect to the central axis of the transmission channel.

The protrusions are symmetrically arranged, so that the consumable may be heated more uniformly and the flow rate is more stable, the printing process is smoother, and the printing quality is improved.

In an embodiment, the hotend further includes a throat part connected to the heating part, and the transmission channel extending through the throat part; the heating part includes a first thermal coupling section, a second thermal coupling section and a third thermal coupling section connected in sequence, the heat conduction part is connected with the second thermal coupling section, the first thermal coupling section is configured to connect to the throat part of the hotend, and the third thermal coupling section is configured to connect to the nozzle part.

In an embodiment, the heat conduction part is spaced apart from the first thermal coupling section; and/or the heat conduction part is adjacent to and in contact with the third thermal coupling section.

The first end of the heat conduction part is spaced apart from the first thermal coupling section of the heating part, so that the consumable after entering the heating part can be preheated, unmelted hard consumable is prevented from directly abutting against the heat conduction part to cause blockage or reduce the printing speed.

The end of the heat conduction part is in contact with the third thermal coupling section, so that the consumable after being sufficiently melted by the heat conduction part can be directly transmitted to the nozzle part, and the smoothness of outfeed the consumable by the nozzle part is improved.

In an embodiment, the first thermal coupling section includes a first receiving cavity, the first receiving cavity is configured to receive a portion of the throat part, and a diameter of the first receiving cavity is larger than a diameter of the transmission channel; and/or the third thermal coupling section includes a second receiving cavity, the second receiving cavity is configured to receive a portion of the nozzle part, and a diameter of the second receiving cavity is lager than the diameter of the transmission channel.

The throat part is embeddedly arranged with the heating part, so that the consumable can be preheated when the consumable is in a transition region between the throat part and the heating part.

The nozzle part is embeddedly arranged with the heating part, so that the melted consumable can be kept warm after reaching the nozzle part.

In an embodiment, the third thermal coupling section includes a protruding structure, the protruding structure protrudes away from the transmission channel relative to an outer wall of the second thermal coupling section; and/or the protruding structure includes a detection hole, the detection hole is configured to receive a temperature sensor, and the temperature sensor is configured to sense a temperature of the hotend.

The protruding structure is capable of enhancing heat conduction effect in cooperation with the nozzle part, and increasing a volume of the heat conduction medium to enhance the heat transfer effect.

The detection hole is provided on the protruding structure, so that the space can be reasonably utilized, the temperature sensor is arranged on the third thermal coupling section, the detected consumable temperature is closer to the actual temperature of the consumable flowing into the nozzle part, and the detection precision of the temperature sensor is improved.

In an embodiment, the third thermal coupling section includes a reverse locking structure, the reverse locking structure is arranged on a side of the third thermal coupling section away from the first thermal coupling section, and the reverse locking structure protrudes towards the transmission channel.

The reverse locking structure is cooperated with the nozzle part to prevent the occurrence of the leakage.

In an embodiment, the throat part includes a radiating section, a transition section and a preheating section connected in sequence, the preheating section is in the first receiving cavity, the preheating section is thermally coupled with the first thermal coupling section, the transition section is thermally coupled with the preheating section, and the radiating section is thermally coupled with the transition section.

In an embodiment, a diameter of the transition section is smaller than a diameter of the preheating section; or a diameter of the transition section is smaller than each of a diameter of the preheating section and a diameter of the radiating section.

The transition section is configured to reduce the direct thermal coupling between the radiating section and the preheating section, to avoid excessive heat loss of the preheating section, and to improve the preheating effect of the preheating section.

In an embodiment, the preheating section includes a first surface at an end away from the radiating section, the second thermal coupling section includes a second surface at an end close to the first thermal coupling section, and the first surface abuts against the second surface.

The preheating section is directly in abutment with the second thermal coupling section after passing through the first thermal coupling section, thereby enhancing the connection between the throat part and the heating part.

In an embodiment, the nozzle part includes a connecting section, a recessed section and a outfeed section connected in sequence, the connecting section and the recessed section are arranged in the second receiving cavity, and the outfeed section is arranged on a side of the recessed section away from the connecting section; and/or a diameter of the recessed section is smaller than each of a diameter of the connecting section and a diameter of the outfeed section, and the recessed section is configured to abut against the reverse locking structure of the third thermal coupling section.

The reverse locking structure and the recessed section are matched in shape, reverse locking is achieved, and the occurrence of material leakage is further avoided.

In an embodiment, the hotend further includes a throat part, the throat part is connected with and thermally coupled with the heating part, the heating part is between the throat part and the nozzle part, and the transmission channel further extends through the throat part, the heating part and the nozzle part in sequence; and/or the transmission channel is divided into a first sub-channel, a second sub-channel and a third sub-channel communicated in sequence, the first sub-channel is in the throat part, the second sub-channel is in the heating part, the third sub-channel is in the nozzle part, and the heat conduction part is located in the second sub-channel.

In an embodiment, at a junction of the throat part and the heating part, a diameter of the first sub-channel is smaller than a diameter of the second sub-channel; and/or at a junction of the heating part and the nozzle part, a diameter of the second sub-channel is smaller than a diameter of the third sub-channel.

In an embodiment, the second sub-channel is divided into a buffer region and a functional region in communication with the buffer region, the buffer region is communicated with the first sub-channel and is spaced apart from the third sub-channel, the functional region is communicated with the third sub-channel and is spaced apart from the first sub-channel, and the heat conduction part is in the functional region.

The application further provides a heat set, including an extrusion assembly and the hotend according to any one of the preceding embodiments, the hotend is connected with the extrusion assembly.

The heat set includes the hotend suitable for high-speed printing, so that the heat set is applicable to high-speed printing.

The application further provides a 3D printing device, comprising a device body, a forming platform and the heat set according to the preceding embodiment, wherein the heat set and the forming platform are movably connected with the device body.

The 3D printing device includes the hotend adapted to high-speed printing, so that the 3D printing device can be configured to realize high-speed printing.

### BRIEF DESCRIPTION OF THE DRAWINGS

FIG. 1 is a schematic diagram of a perspective view of a hotend according to an embodiment of the disclosure.

FIG. 2 is a schematic diagram of a perspective view of the hotend according to the embodiment of the disclosure.

FIG. 3 is a schematic diagram of an exploded view of the hotend according to the embodiment of the disclosure.

FIG. 4 is a schematic diagram of a sectional view in a first direction of the hotend according to the embodiment of the disclosure.

FIG. 5 is a schematic diagram of an exploded view of the sectional view of the hotend, viewed in the first direction, according to the embodiment of the disclosure.

FIG. 6 is a schematic diagram of an exploded view of a sectional view in a second direction of the hotend according to the embodiment of the disclosure.

FIG. 7 is a schematic diagram of another exploded view of the sectional view of the hotend, viewed in the second direction, according to the embodiment of the disclosure.

FIG. 8 is a schematic diagram of another exploded view of the sectional view of the hotend, viewed in the second direction, according to the embodiment of the disclosure.

FIG. 9 is a schematic diagram of a perspective view of a head set according to an embodiment of the disclosure.

FIG. 10 is a schematic diagram of a perspective view of a 3D printing device according to an embodiment of the disclosure.

### EXPLANATION OF MAIN ELEMENT SYMBOLS

Hotend 10, nozzle part 101, radiating section 1011, transition section 1012, preheating section 1013, first surface 1014, heating part 102, inner wall 1020, first thermal coupling section 1021, external thread 10211, second surface 10212, first receiving cavity 10213, second thermal coupling section 1022, outer wall 10221, third thermal coupling section 1023, protruding structure 10231, second receiving cavity 10232, third surface 10233, fifth surface 10234, reverse locking structure 10235, detection hole 10236, seventh surface 10237, heat conduction part 1024, protrusion 1025, first end 10251, second end 10252, concave portion 1026, nozzle part 103, connecting section 1031, fourth surface 10311, sixth surface 10312, recessed section 1032, outfeed section 1033, eighth surface 10331, outfeed port 10332, transmission channel 104, first sub-channel 1041, second sub-channel 1042, buffer region 10421, functional region 10422, third sub-channel 1043, head set 100, extrusion assembly 11, 3D printing device 1, device body 12, forming platform 13, first direction X, second direction Y

The following detailed description will further illustrate the disclosure in conjunction with the above figures.

### DETAILED DESCRIPTION

The description will be set forth in conjunction with the drawings. The drawings are intended to illustrate the exemplary embodiments of the disclosure. Furthermore, the disclosure can be embodied in many different forms and should not be construed as being limited to the exemplary embodiments set forth herein. These exemplary embodiments are provided so that the disclosure will be thorough and complete, and will fully convey the scope of the disclosure to those skilled in the art. Similar reference numerals refer to same or similar components throughout. The terminology used herein is for the purpose of describing particular exemplary embodiments only and is not intended to be limiting of the disclosure. As used herein, the singular forms “a”, “an” and “the” are intended to include the plural forms as well, unless the context clearly indicates otherwise. Furthermore, to the extent that the terms “including”, “includes”, “having”, “has”, “with”, and/or “containing”, integers, steps, operations, components, and/or components are used in this disclosure, such terms are open-ended, and include one or more of the features, elements, integers, steps, operations, components, and/or groups thereof, but does not preclude the presence or addition of one or more other features, regions, integers, steps, operations, components, and/or groups thereof. Unless otherwise defined, all terms (including technical and scientific terms) used herein have the same meaning as commonly understood by one of ordinary skill in the art to which this application belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein. The following description will be made with reference to the accompanying drawings. It should be noted that the components depicted in the drawings are not necessarily shown to scale; rather, the same or similar components will be given the same or similar reference numerals and/or similar technical terms.

Generally, the existing hotend suitable for low-speed printing and medium-speed printing cannot be applied to high-speed printing process. When the nozzle structure suitable for low-speed printing and medium-speed printing is applied to high-speed printing, various problems such as insufficient melting of consumables, large viscosity of consumables, far lower printing speed than expected, material blocking, large printing pressure, poor forming quality, etc. occur, so that the expected high-speed printing cannot be realized. How to solve the above problems and provide a nozzle structure that can adapt to high-speed printing is a problem that those skilled in the art need to consider.

Embodiments of the application provides a hotend, which includes a heating part, a nozzle part, a transmission channel and a heat conduction part. The transmission channel passes through the heating part and the nozzle part, the transmission channel includes an inner wall, and the heating part is configured for generating or transferring heat to increase a temperature in the transmission channel. The heat conduction part is arranged in the transmission channel and is thermally coupled with the heating part, and the heat conduction part includes protrusions, the protrusions protruding in a direction from the inner wall to a central axis of the transmission channel.

In the hotend of the disclosure, the heating part is configured for generating or transferring heat to increase the temperature in the transmission channel, and the consumable entering the heating part through the transmission channel is gradually melted by heat so as to be ejected for printing subsequently. The heat conduction part is thermally coupled with the heating part. The contact of consumables with the heat conducting part and the conduction of heat can cause the consumables to melt. The heat conduction part protruding into the transmission channel can be directly in contact with a middle part (or a part far from the inner wall) of the consumable to conduct heat, the consumable is heated more uniformly and melted more sufficiently, reducing viscosity of the melted consumable and printing pressure, and increasing the melting speed of the consumable to avoid occurrence of blockage, and forming quality is improved. In the hotend, the heating process of whole of the consumable is smooth, the consumable can be uniformly heated and sufficiently melted in a short time, and blockage is not prone to occur, a lubricating layer can be further formed between the melted consumable and the inner wall, the hotend is capable of being applied to a high-speed printing process, and various problems such as insufficient melting of the consumable, high viscosity of the consumable, a printing speed much lower than an expected value, blockage, high printing pressure, and poor forming quality can be solved.

Those skilled in the art can understand that the “3D printing device” refers to a device capable of realizing three-dimensional printing (additive manufacturing).

Those skilled in the art can understand that “thermal coupling” refers to a heat transfer connection, which can be achieved by heat transfer, heat convection or heat radiation, or any combination of the three methods.

Those skilled in the art can understand that the “consumable” refers to a rod-shaped thermoplastic material in a solid state at a room temperature, the consumable can be melted when heated, and then cooled to form.

Embodiments of the application are described in detail below with reference to the drawings.

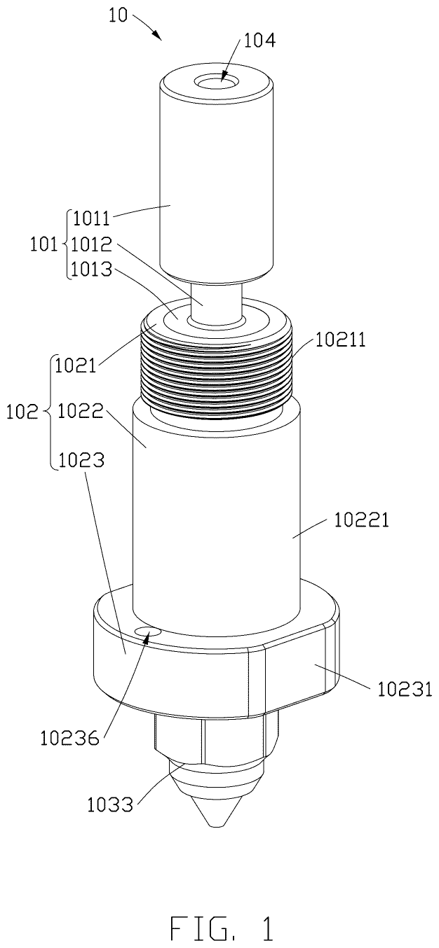

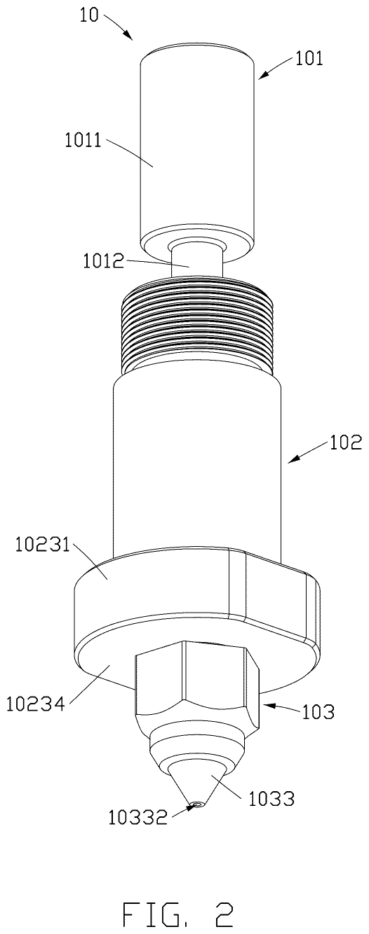

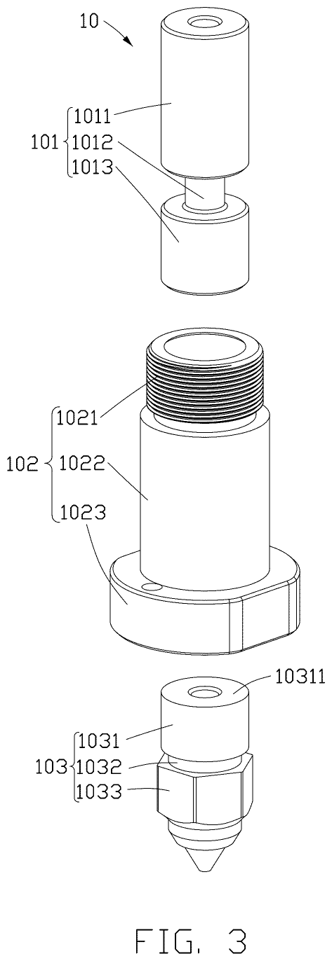

Referring to FIG. 1 to FIG. 3, an embodiment of the application provides a hotend 10, which includes a throat part 101, a heating part 102, a nozzle part 103, a transmission channel 104 and a heat conduction part 1024. The heating part 102 is between the throat part 101 and the nozzle part 103, the throat part 101 is connected with and thermally coupled with the heating part 102, the nozzle part 103 is connected with and thermally coupled with the heating part 102, and the heat conduction part 1024 is connected with and thermally coupled with the heating part 102. The transmission channel 104 passes through the throat part 101, the heating part 102 and the nozzle part 103 in sequence, and a consumable (not shown) may pass through the throat part 101, the heating part 102 and the nozzle part 103 in sequence through the transmission channel 104.

The throat part 101 is at least configured for guiding, preheating and dissipating the consumable, the heating part 102 is at least configured for generating or transferring heat to increase the temperature in the transmission channel 104, the nozzle part 103 is at least configured for extruding the melted consumable, and the transmission channel 104 is configured for at least transmitting, containing and guiding the consumable. The transmission channel 104 has an inner wall 1020, the heat conduction part 1024 is located in the transmission channel 104, the heat conduction part 1024 is arranged in the transmission channel 104 and is thermally coupled with the heating part 102, and the heat conduction part 1024 includes protrusions 1025 protruding in a direction from the inner wall 1020 to a central axis of the transmission channel 104.

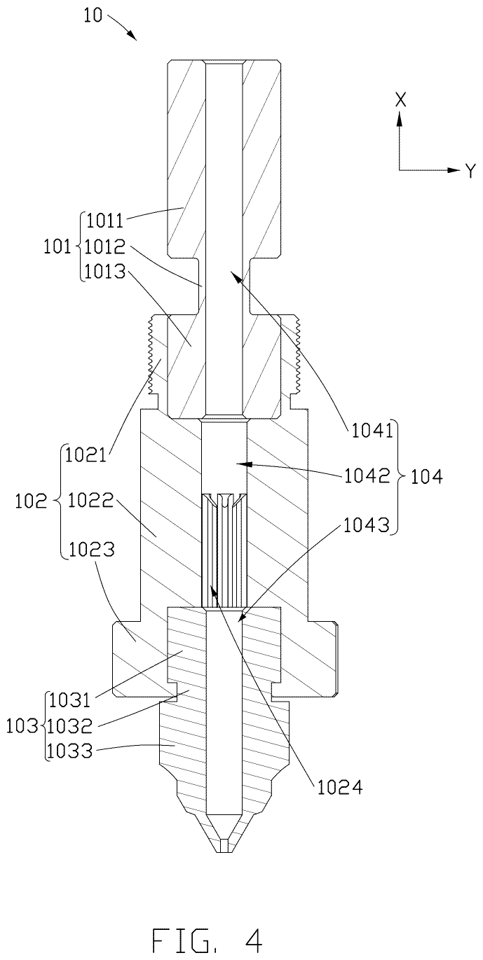

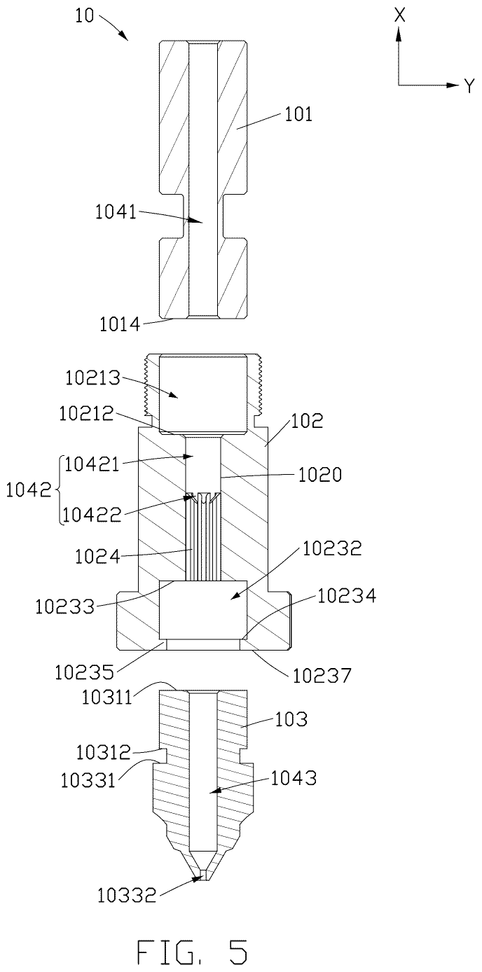

Further referring to FIG. 4 and FIG. 5, in an embodiment, the transmission channel 104 is divided into a first sub-channel 1041, a second sub-channel 1042 and a third sub-channel 1043 which are sequentially communicated. The first sub-channel 1041 is in the throat part 101, the second sub-channel 1042 is in the heating part 102, the third sub-channel 1043 is in the nozzle part 103, and the heat conduction part 1024 is in the second sub-channel 1042.

In an embodiment, the second sub-channel 1042 is divided into a buffer region 10421 and a functional region 10422 which are communicated, the buffer region 10421 is communicated with the first sub-channel 1041 and is spaced from the third sub-channel 1043, the functional region 10422 is communicated with the third sub-channel 1043 and is spaced from the first sub-channel 1041, and the heat conduction part 1024 is in the functional region 10422.

The heating part 102 is configured for generating or transferring heat to increase the temperature in the transmission channel 104, and the consumable entering the heating part 102 through the transmission channel 104 is gradually melted by heat to facilitate subsequent ejection printing. The heat conduction part 1024 is thermally coupled with the heating part 102. The contact of consumables with the heat conducting part 1024 and the conduction of heat can cause the consumables to melt. The heat conduction part 1024 protruding into the transmission channel 104 can directly contact and conduct heat with a middle part (or the part of the consumable which is far away from the inner wall 1020) of the consumable, the consumable is heated more uniformly and melted more sufficiently, the middle part of the consumable is prevented from being heated to a degree much lower than that of a part of the consumable directly contacting the inner wall 1020 due to too high flow rate, the viscosity of the melted consumable is reduced, the printing pressure is reduced, the melting speed of the consumable is increased to prevent the occurrence of blockage, and the forming quality is improved.

In the hotend 10 of the disclosure, the heating process of whole of the consumable is smooth, the consumable may be uniformly heated and sufficiently melted in a short time, and blockage is not prone to occur, a lubricating layer may be further formed between the melted consumable and the inner wall 1020, the hotend 10 is capable of being applied to a high-speed printing process, and various problems such as insufficient melting of the consumable, high viscosity of the consumable, a printing speed much lower than an expected value, blockage, high printing pressure, and poor forming quality can be solved.

In embodiments, the transmission channel 104 is arranged in a straight line, and the first direction X is a extension direction of the transmission channel 104. The second direction Y is perpendicular to the first direction X, and the second direction Y may be any direction on a plane perpendicular to the first direction X.

In an embodiment, a diameter of the first sub-channel 1041 is smaller than a diameter of the second sub-channel 1042 at a junction of the throat section 101 and the heating section 102; and/or the diameter of the second sub-channel 1042 is smaller than a diameter of the third sub-channel 1043 at the junction of the heating section 102 and the nozzle section 103.

In the transmission process, the consumable sequentially passes through the first sub-channel 1041, the second sub-channel 1042 and the third sub-channel 1043 along the first direction X, and at the respective junctions, the diameter of the first sub-channel 1041 is smaller than the diameter of the second sub-channel 1042; and/or the diameter of the second sub-channel 1042 is smaller than the diameter of the third sub-channel 1043, which can reduce risk of material leakage in the transmission process of the consumable.

Further referring to FIG. 1 to FIG. 5, in an embodiment, the heat conduction part 1024 includes a first end 10251 and a second end 10252 spaced apart. The first end 10251 is connected with the inner wall 1020, and the second end 10252 protrudes towards the central axis of the transmission channel 104 to form protrusions 1025 spaced apart from each other. The protruding direction of the protrusions 1025 is along the second direction Y.

The second end 10252 protrudes towards a middle part of the transmission channel 104, so that the central part of the consumable flowing through the middle part can be directly contacted and heated by the second end 10252, the uniformity of the melting of the consumable is improved, the melting of the consumable is more sufficient, the viscosity of the consumable and the printing pressure are reduced, the fully melted consumable can flow away quickly and is not easy to be blocked, and the printing speed is improved.

In an embodiment, each protrusion 1025 does not contact each other, and the first end 10251 between any two adjacent protrusions 1025 is configured to form a concave portion 1026.

Each protrusion 1025 does not contact each other, so that the part of the transmission channel 104 (especially the second sub-channel 1042) corresponding to an area where the heat conduction part 1024 located is not blocked by the heat conduction part 1024. The transmission channel 104 (especially the second sub-channel 1042) is a complete communication area, and the melted consumable can have a higher flow rate when passing through the transmission channel 104. The plurality of concave portions 1026 are all located in the functional region 10422, the plurality of concave portions 1026 are communicated with each other, and the transmission channel 104 is not separated by the protrusions 1025, to prevent the flow rate of the consumable form being reduced. The flow rate of the consumable is improved, and the blocking of the consumable is avoided.

In an embodiment, the protrusions 1025 are arranged along the first direction X, and the first direction X is the extension direction of the transmission channel 104; and/or a plurality of concave portions 1026 are arranged along the first direction X, and the first direction X is the extension direction of the transmission channel 104.

The protrusions 1025 and/or the concave portions 1026 are arranged along the extension direction of the transmission channel 104, on the one hand, the consumables are gradually heated and kept warm in the process of flowing through the transmission channel 104, the uniformity of the melting of the consumables is improved to ensure the printing quality, on the other hand, hindrance to the flow process of the melted consumables is minimized, and the flow rate is improved.

In an embodiment, a width of the convex portion 1025 in a cross section gradually decreases from the first end 10251 to the second end 10252.

In an embodiment, a width of the concave portion 1026 in a cross section gradually increases from the second end 10252 to the first end 10251.

The gradually narrowed convex portion 1025 corresponds to the transmission channel 104 with a circular cross-section, the width of the concave portion 1026 between adjacent protrusions 1025 is substantially the same or equidistantly distributed, so that the flow rate of the consumables flowing through the concave portion 1026 and the heating condition of the consumables are kept reasonably balanced.

In an embodiment, a top portion of the second end 10252 includes a continuous circular arc surface.

The second end 10252 with the arc-shaped top can improve the flow rate of the consumables and make the overall flow rate of the melted consumables more stable.

In an embodiment, the protrusions 1025 are arranged symmetrically with respect to the central axis of the transmission channel 104.

The symmetrical arrangement of the protrusions 1025 makes the overall heating of the consumables more uniform, the flow rate more stable, the printing process more stable, and the printing quality improved.

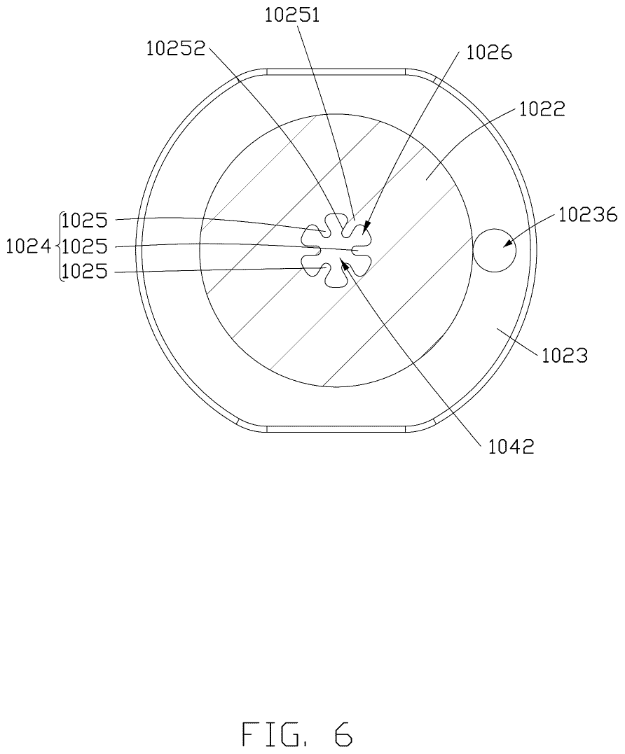

Further referring to FIG. 6, in an embodiment, the heat conduction part 1024 includes six protrusions 1025.

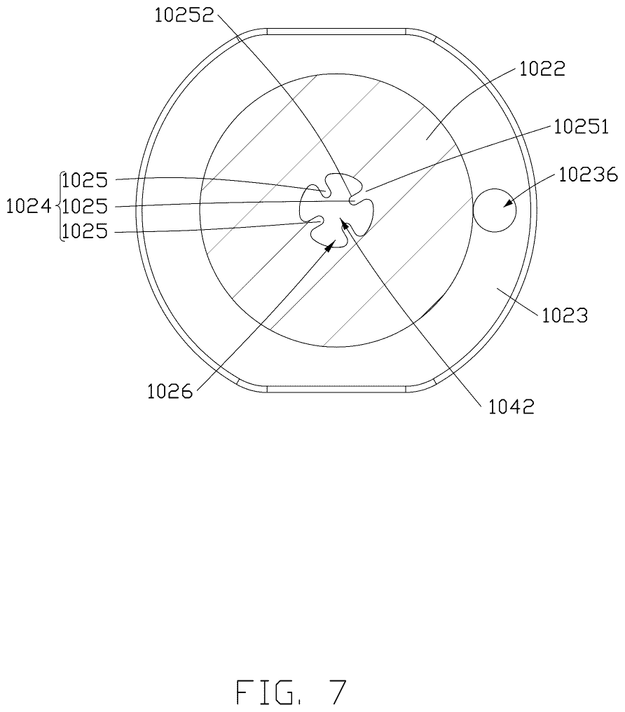

Further referring to FIG. 7, in an embodiment, the heat conduction part 1024 includes four protrusions 1025.

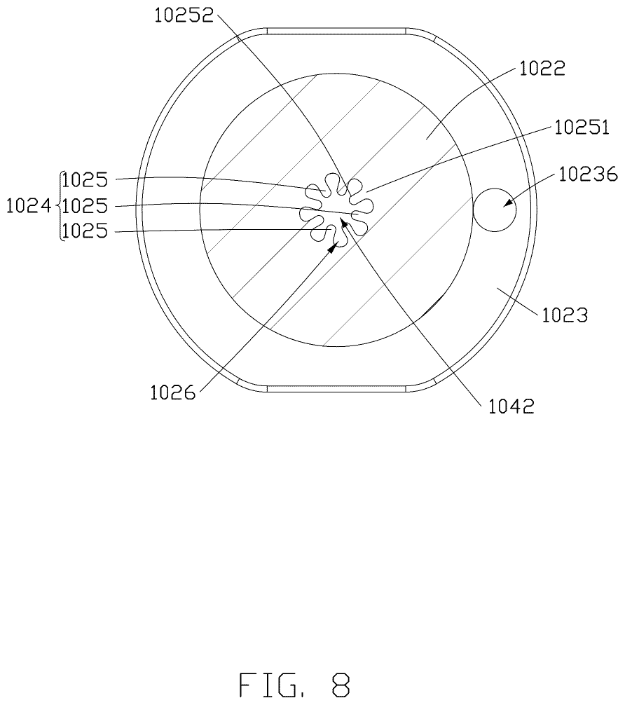

Further referring to FIG. 8, in an embodiment, the heat conduction part 1024 includes eight protrusions 1025.

The number of protrusions 1025 can be selected according to the specific flow rate or other printing requirements, and the number of protrusions 1025 can be other, and the protrusions 1025 are preferably distributed in an axial symmetry.

Further referring to FIG. 1 to FIG. 5, in an embodiment, the throat part 101 includes a radiating section 1011, a transition section 1012 and a preheating section 1013 connected in sequence. The preheating section 1013 is in the first receiving cavity 10213, the preheating section 1013 is thermally coupled with the first thermal coupling section 1021, the transition section 1012 is thermally coupled with the preheating section 1013, and the radiating section 1011 is thermally coupled with the transition section 1012.

The preheating section 1013 is configured for being in direct contact with the heating part 102 and being thermally coupled to achieve preheating of the consumable. The radiating section 1011 is configured for dissipating heat of the throat part 101 and even the whole hotend 10, and a periphery of the radiating section 1011 can be sleeved with a heat sink (not shown in the figure). The transition section 1012 is configured for separating the preheating section 1013 and the radiating section 1011, reducing direct contact between the radiating section 1011 and the preheating section 1013, and improving the preheating effect of the preheating section 1013.

In an embodiment, a diameter of the transition section 1012 is smaller than a diameter of the radiating section 1011, and the diameter of the transition section 1012 is smaller than a diameter of the preheating section 1013.

The transition section 1012 is configured for reducing direct thermal coupling between the radiating section 1011 and the preheating section 1013, avoiding excessive heat loss of the preheating section 1013, and improving the preheating effect of the preheating section 1013.

In an embodiment, the preheating section 1013 includes a first surface 1014 at an end away from the radiating section 1011, the second thermal coupling section 1022 includes a second surface 10212 at an end close to the first thermal coupling section 1021, and the first surface 1014 abuts against the second surface 10212.

The preheating section 1013 is in direct abutment with the second thermal coupling section 1022 after passing through the first thermal coupling section 1021, and the connection between the throat part 101 and the heating part 102 is enhanced.

The consumable is usually made of plastic, for example, polylactic acid (PLA).

Thermal creep is a phenomenon that plastic softens and plastically deforms, which is embodied as a change in viscosity of the material. The inventors have found that the viscosity of the low-temperature high-elasticity fluid is not in a same order of magnitude as that of the completely melted fluid, and the viscosity of the low-temperature high-elasticity fluid is much greater than that of the completely melted fluid, which greatly increases the extrusion force requirement of the low-temperature fluid section. The thermal creep phenomenon mainly occurs in the throat part 101 (the radiating section 1011, the transition section 1012, and the preheating section 1013), and therefore, the throat part 101 in one or more embodiments of the application adopts following designs:

1. Since there is usually an air gap of at least 0.01 mm at the joint of the radiating section 1011 and the heat sink in assembly design, a preset temperature of the heat sink should have a temperature margin below it, for example, the temperature of the heat sink should not be higher than a temperature at which the consumable starts to soften (such as 50-60° C.) in a high-temperature environment (such as 35-45° C.).

2. The air gap between the radiating section 1011 and the heat sink can be filled with thermally conductive silicone grease, and radial thermal resistance between the radiating section 1011 and the heat sink can be reduced by about two orders of magnitude. Similarly, thermally conductive silicone grease can also be filled in a connection gap between the heating part 102 and the nozzle part 103.

3. A tube wall of the transition section 1012 should be as thin as possible, and the material of the transition section 1012 is preferably a low-thermal-conductivity titanium alloy (for example, Ti₆Al₄V), and on this basis, a length of the transition section 1012 can be as short as possible to reduce softening length. The metal titanium with high strength and light weight can help reduce the overall mass of the hotend 10, reduce the load when the hotend 10 moves, and help improve the printing speed.

4. The materials of the radiating section 1011 and the preheating section 1013 are preferably high-thermal-diffusivity metal materials, which can improve the heating temperature and reduce the thermal resistance between the heat sink and the consumables.

Further referring to FIG. 1 to FIG. 5, in an embodiment, the heating part 102 includes a first thermal coupling section 1021, a second thermal coupling section 1022, and a third thermal coupling section 1023 connected in sequence. The heat conduction part 1024 is connected with the second thermal coupling section 1022, the first thermal coupling section 1021 is configured for being connected with the throat part 101 of the hotend 10, and the third thermal coupling section 1023 is configured for being connected with the nozzle part 103.

In an embodiment, the heat conduction part 1024 is spaced apart from the first thermal coupling section 1021.

An end of the heat conduction part 1024 is spaced apart from the first thermal coupling section 1021 of the heating part 102 for feeding, so that the consumables entering the heating part 102 can be preheated, and unmelted hard consumables are prevented from being directly abutted against the heat conduction part 1024 to cause blockage or reduce the printing speed. Specifically, the buffer region 10421 included in the second sub-channel 1042 can be used to prevent the junction (the junction of the first thermal coupling section 1021 and the preheating section 1013) from being directly connected with the functional region 10422 (provided with the heat conduction part 1024), so as to prevent consumables with different fluid viscosities (different viscosities caused by different temperatures of the consumables) from being accumulated to the junction under suddenly increased extrusion pressure (the extrusion area is reduced due to the presence of the heat conduction part 1024 in the functional region) to cause material stacking or blockage.

In an embodiment, the heat conduction part 1024 is adjacent to and in contact with the third thermal coupling section 1023.

The end of the heat conduction part 1024 is in contact with the third thermal coupling section 1023, so that the consumables sufficiently melted by the heat conduction part 1024 can be directly transmitted to the nozzle part 103, and the smoothness of outfeed of the nozzle part 103 is improved.

In an embodiment, a first receiving cavity 10213 is defined in the first thermal coupling section 1021, the first receiving cavity 10213 is configured for receiving part of the throat part 101, and a diameter of the first receiving cavity 10213 is greater than the diameter of the transmission channel 104.

The first receiving cavity 10213 is configured for receiving the preheating section 1013, the throat part 101 and the heating part 102 are interlocked, so that the consumables can be preheated when the consumables in a transition area between the throat part 101 and the heating part 102.

In an embodiment, an outer surface of the first thermal coupling section 1021 includes an external thread 10211.

The external thread 10211 can be configured to detachably connect the hotend 10 with an external structure (for example, the extrusion assembly 11).

In the embodiment, the second thermal coupling section 1022 is in a cylindrical shape, and the second thermal coupling section 1022 can be sleeved with a hollow cylindrical ceramic heating ring (not shown in the figure) for generating heat by being electrified. The second thermal coupling section 1022 is thermally coupled with the ceramic heating ring, and the heat generated by the ceramic heating ring is transferred to the transmission channel 104 through the second thermal coupling section 1022 to melt the consumable.

In other embodiments, the second thermal coupling section 1022 may be a functional structure having a heat generation capability, for example, electric heating wires for generating heat embedded in the second thermal coupling section 1022.

In an embodiment, the third thermal coupling section 1023 includes a protruding structure 10231 protruding away from the transmission channel 104 relative to the outer wall 10221 of the second thermal coupling section 1022.

The protruding structure 10231 can enhance heat conduction effect in cooperation with the nozzle part 103, and increase the heat transfer effect by increasing the volume of the heat conduction medium.

In an embodiment, a detection hole 10236 is provided on the protruding structure 10231, and the detection hole 10236 is configured to receive a temperature sensor (not shown in the figure), and the temperature sensor is configured to sense a temperature of the hotend 10.

In an embodiment, the detection hole 10236 is a blind hole formed in the first direction X. In other embodiments, the detection hole 10236 may be a blind hole or a through hole formed in other directions.

In an embodiment, the temperature sensor may be a thermistor. In other embodiments, the temperature sensor may be other electronic components capable of sensing heat.

The detection hole 10236 is formed in the protruding structure 10231, on the one hand, the space can be reasonably utilized, and on the other hand, the temperature sensor is arranged in the third thermal coupling section 1023, so that the detected temperature of the consumable is closer to the actual temperature of the consumable flowing into the nozzle part 103, and the detection precision of the temperature sensor is improved.

In an embodiment, the third thermal coupling section 1023 includes a reverse locking structure 10235, the reverse locking structure 10235 is arranged on a side of the third thermal coupling section 1023 away from the first thermal coupling section 1021, and the reverse locking structure 10235 protrudes towards the transmission channel 104.

In an embodiment, the reverse locking structure 10235 is connected with the protruding structure 10231 and arranged around the periphery of the transmission channel 104, and the reverse locking structure 10235 protrudes in the second direction Y.

The reverse locking structure 10235 cooperates with the nozzle part 103 to avoid the occurrence of material leakage.

The heating part 102, the nozzle part 103, and the throat part 101 may be connected in various manners, for example, threaded connection, buckle connection, welding, one-piece forming, or the like. The heating part 102, the nozzle part 103, and the throat part 101 may be integrally formed, fixedly connected, or detachably connected with each other, and preferably, are threaded connection. The reverse locking structure 10235 may be made of an elastic deformation material or a flexible material, and when the heating part 102 and the nozzle part 103 are connected by threads, the reverse locking structure 10235 does not interfere with the installation of the heating part 102 and the nozzle part 103, and can also provide a leak-proof function.

Further referring to FIG. 1 to FIG. 5, in an embodiment, the nozzle part 103 includes a connecting section 1031, a recessed section 1032, and a outfeed section 1033 connected in sequence. The connecting section 1031 and the recessed section 1032 are arranged in the second receiving cavity 10232, and the outfeed section 1033 is arranged on a side of the recessed section 1032 away from the connecting section 1031.

In an embodiment, the third thermal coupling section 1023 includes the second receiving cavity 10232, the second receiving cavity 10232 is configured for receiving part of the nozzle part 103, and a diameter of the second receiving cavity 10232 is greater than a diameter of the transmission channel 104.

The second receiving cavity 10232 is configured for receiving the connecting section 1031 of the nozzle part 103, and the nozzle part 103 is interlocked with the heating part 102, so that molten consumable may be kept warm after reaching the nozzle part 103.

In an embodiment, the second thermal coupling section 1022 includes a third surface 10233 at an end away from the first thermal coupling section 1021, the connecting section 1031 includes a fourth surface 10311 at an end facing the second thermal coupling section 1022, and the third surface 10233 abuts against the fourth surface 10311.

The second thermal coupling section 1022 is directly in abutment with the connecting section 1031 and communicates the transmission channel 104, and meanwhile, the third surface 10233 and the fourth surface 10311 are in abutment, so that the leakage of the material can be avoided.

In an embodiment, a diameter of the recessed section 1032 is less than the diameter of the connecting section 1031 and the diameter of the outfeed section 1033, and the recessed section 1032 is configured for abutting against the reverse locking structure 10235 of the third thermal coupling section 1023.

The recessed section 1032 is recessed along the second direction Y, the reverse locking structure 10235 and the recessed section 1032 are matched with each other in shape, reverse locking is achieved, and the leakage of the material can be further avoided.

In an embodiment, the shape matching of the reverse locking structure 10235 and the recessed section 1032 may be: the fifth surface 10234 of the reverse locking structure 10235 close to the second thermal coupling section 1022 is in mutual abutment with the sixth surface 10312 of the connecting section 1031 close to the recessed section 1032. Alternatively, the shape matching of the reverse locking structure 10235 and the recessed section 1032 may be: the seventh surface 10237 of the reverse locking structure 10235 away from the second thermal coupling section 1022 is in mutual abutment with the eighth surface 10331 of the outfeed section 1033 close to the recessed section 1032.

In an embodiment, the outfeed section 1033 includes an outfeed opening 10332 on a side away from the connecting section 1031, and the transmission channel 104 is narrowed at the outfeed opening 10332 and communicates with the outfeed opening 10332, so that the molten consumable is extruded from the outfeed opening 10332 to achieving printing.

Referring to Table 1, the experimental data of extrusion experiments of the hotend 10 of embodiments of the application and existing common hotend are listed. The “4-split hotend” is the structure shown in FIG. 7, the “6-split hotend” is the structure shown in FIG. 6, and the “8-split hotend” is the structure shown in FIG. 8. The “2-split hotend” is not shown in the figures, and the “2-split hotend” is a hotend in which the guide conduction part 1024 includes two protrusions 1025. The “common hotend” is not provided with a protrusion.

TABLE 1

| Temperature | | | Extrusion length (mm) | | | | | | | | | | | |
|---|---|---|---|---|---|---|---|---|---|---|---|---|---|---|
| (° C.) | | | 500 | 500 | 500 | 500 | 500 | 500 | 500 | 500 | 500 | 500 | 500 | 500 |
| 230 | Printing speed | | 50 | 100 | 150 | 200 | 250 | 300 | 350 | 400 | 450 | 500 | 550 | 600 |
| | (mm/s) | | | | | | | | | | | | | |
| 230 | Theoretical | | 1.48 | 1.48 | 1.48 | 1.48 | 1.48 | 1.48 | 1.48 | 1.48 | 1.48 | 1.48 | 1.48 | 1.48 |
| | extrusion mass (g) | | | | | | | | | | | | | |
| 230 | Actual | Common | 1.52 | 1.51 | 1.52 | 1.49 | 1.48 | 1.41 | 1.14 | 0.92 | 0.77 | 0.67 | 0.57 | 0.46 |
| | extrusion | hotend | | | | | | | | | | | | |
| 250 | mass (g) | Common | 1.53 | 1.52 | 1.52 | 1.49 | 1.49 | 1.45 | 1.27 | 1.03 | 0.89 | 0.82 | 0.76 | 0.5 |
| | | hotend | | | | | | | | | | | | |
| 230 | | 2-split | 1.5 | 1.49 | 1.5 | 1.48 | 1.48 | 1.46 | 1.45 | 1.41 | 1.38 | 1.35 | 1.22 | 1.13 |
| | | hotend | | | | | | | | | | | | |
| 250 | | 2-split | 1.52 | 1.52 | 1.49 | 1.5 | 1.48 | 1.47 | 1.44 | 1.46 | 1.42 | 1.38 | 1.32 | 1.27 |
| | | hotend | | | | | | | | | | | | |
| 230 | | 4-split | 1.49 | 1.48 | 1.49 | 1.48 | 1.47 | 1.46 | 1.45 | 1.44 | 1.41 | 1.37 | 1.33 | 1.25 |
| | | hotend | | | | | | | | | | | | |
| 250 | | 4-split | 1.49 | 1.49 | 1.48 | 1.48 | 1.47 | 1.46 | 1.47 | 1.46 | 1.43 | 1.41 | 1.38 | 1.36 |
| | | hotend | | | | | | | | | | | | |
| 230 | | 6-split | 1.48 | 1.48 | 1.47 | 1.46 | 1.46 | 1.45 | 1.45 | 1.44 | 1.43 | 1.4 | 1.37 | 1.31 |
| | | hotend | | | | | | | | | | | | |
| 250 | | 6-split | 1.5 | 1.5 | 1.5 | 1.48 | 1.46 | 1.48 | 1.46 | 1.47 | 1.45 | 1.44 | 1.41 | 1.37 |
| | | hotend | | | | | | | | | | | | |
| 230 | | 8-split | 1.48 | 1.47 | 1.47 | 1.46 | 1.45 | 1.43 | 1.44 | 1.44 | 1.43 | 1.43 | 1.41 | 1.39 |
| | | hotend | | | | | | | | | | | | |
| 250 | | 8-split | 1.49 | 1.49 | 1.49 | 1.47 | 1.48 | 1.47 | 1.46 | 1.47 | 1.47 | 1.46 | 1.46 | 1.44 |
| | | hotend | | | | | | | | | | | | |

As shown in Table 1, in the low-speed printing or medium-speed printing process in which the printing speed is lower than 300 m/s, the extrusion mass of the common hotend, the 2-split hotend, the 4-split hotend, the 6-split hotend, and the 8-split hotend are similar. However, in the high-speed printing process in which the printing speed is higher than or equal to 300 m/s, the extrusion qualities of the 2-split hotend, the 4-split hotend, the 6-split hotend, and the 8-split hotend are higher than that of the common hotend, and as the printing speed increases, the extrusion qualities of the 2-split hotend, the 4-split hotend, the 6-split hotend, and the 8-split hotend gradually become higher than that of the common hotend. In particular, the 4-split hotend, the 6-split hotend, and the 8-split hotend shown in the figures of the application still have good extrusion masses when applied to high-speed printing. The hotend 10 in the disclosure is suitable for high-speed printing.

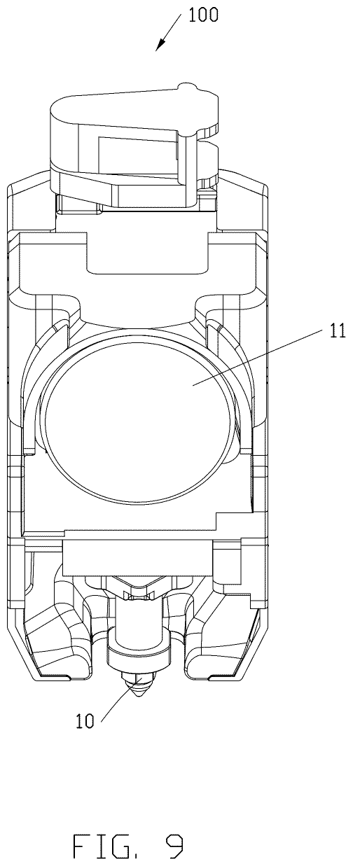

Further referring to FIG. 9, an embodiment of the disclosure further provides a head set 100, which includes the extrusion assembly 11 and the hotend 10, and the hotend 10 is connected with the extrusion assembly 11.

The head set 100 of the application includes the hotend 10 adapted to high-speed printing, so that the head set 100 is applicable to high-speed printing.

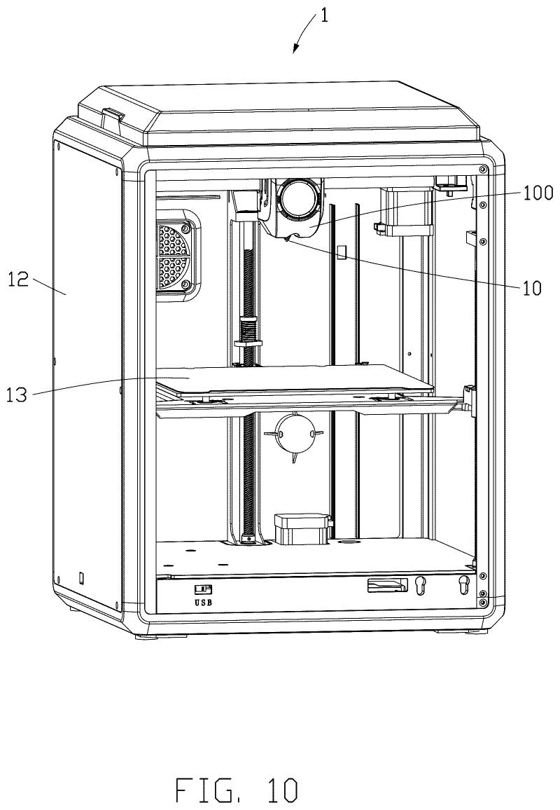

Further referring to FIG. 10, an embodiment of the application further provides a 3D printing device 1, which includes a device body 12, a forming platform 13, and the head set 100, and the head set 100 and the forming platform 13 are respectively movably connected with the device body 12.

The 3D printing device 1 includes the hotend 10 adapted to high-speed printing, so that the 3D printing device 1 is capable of achieving high-speed printing, and the 3D printing device 1 may further include other necessary functional units for realizing 3D printing, which will not be described herein.

In the description, the embodiments of the disclosure are described with reference to the drawings. However, it can be understood by those skilled in the art that various changes and substitutions can be made to the embodiments of the disclosure without departing from the scope of the disclosure. These changes and substitutions are all within the scope defined by the disclosure.

1. A hotend comprising:
a heating part;
a nozzle part;
a transmission channel extending through the heating part and the nozzle part, the transmission channel comprising an inner wall, and configured to be heated by the heating part; and
a heat conduction part arranged in the transmission channel and thermally coupled to the heating part, the heat conduction part comprising protrusions protruding from the inner wall to a central axis of the transmission channel.

2. The hotend of claim 1, wherein the heat conduction part further comprises a first end and a second end spaced apart from the first end, the first end is connected to the inner wall, the second end protrudes towards the central axis of the transmission channel to form the protrusions spaced apart from each other.

3. The hotend of claim 2, wherein the protrusions are not in contact with each other, and a first end between any two adjacent protrusions is configured to form a concave portion.

4. The hotend of claim 3, wherein the protrusions are arranged in a first direction, wherein the first direction is an extension direction of the transmission channel; and a plurality of concave portions formed by the concave portion is arranged in the first direction, wherein the first direction is the extension direction of the transmission channel.

5. The hotend of claim 3, wherein a width of one protrusion of the protrusions in a cross section gradually decreases from the first end to the second end; and a width of the concave portion in a cross section gradually increases from the second end to the first end.

6. The hotend of claim 2, wherein the protrusions are arranged symmetrically with respect to the central axis of the transmission channel.

7. The hotend of claim 1, the hotend further comprises a throat part connected to the heating part, the transmission channel further extending through the throat part; the heating part comprises a first thermal coupling section, a second thermal coupling section, and a third thermal coupling section connected in sequence, the heat conduction part connected to the second thermal coupling section, the first thermal coupling section configured to connect to the throat part, the third thermal coupling section configured to connect to the nozzle part.

8. The hotend of claim 7, wherein the heat conduction part is spaced apart from the first thermal coupling section; and the heat conduction part is adjacent to and in contact with the third thermal coupling section.

9. The hotend of claim 7, wherein the first thermal coupling section comprises a first receiving cavity configured to receive at least a portion of the throat part, a diameter of the first receiving cavity is larger than a diameter of the transmission channel; and the third thermal coupling section comprises a second receiving cavity configured to receive at least a portion of the nozzle part, a diameter of the second receiving cavity is larger than the diameter of the transmission channel.

10. The hotend of claim 7, wherein the third thermal coupling section comprises a protruding structure, wherein the protruding structure protrudes away from the transmission channel relative to an outer wall of the second thermal coupling section; and the protruding structure comprises a detection hole, wherein the detection hole is configured to receive a temperature sensor, the temperature sensor being configured to sense a temperature of the hotend.

11. The hotend of claim 7, wherein the third thermal coupling section comprises a reverse locking structure, the reverse locking structure is arranged on a side of the third thermal coupling section away from the first thermal coupling section, the reverse locking structure protrudes towards the transmission channel.

12. The hotend of claim 9, wherein the throat part comprises a radiating section, a transition section, and a preheating section connected in sequence, the preheating section is in the first receiving cavity, the preheating section is thermally coupled with the first thermal coupling section, the transition section is thermally coupled with the preheating section, and the radiating section is thermally coupled with the transition section.

13. The hotend of claim 12, wherein a diameter of the transition section is smaller than a diameter of the preheating section; or a diameter of the transition section is smaller than each of a diameter of the preheating section and a diameter of the radiating section.

14. The hotend of claim 12, wherein the preheating section comprises a first surface at an end away from the radiating section, the second thermal coupling section comprises a second surface at an end close to the first thermal coupling section, and the first surface abuts against the second surface.

15. The hotend of claim 9, wherein the nozzle part comprises a connecting section, a recessed section, and an outfeed section connected in sequence, the connecting section and the recessed section are arranged in the second receiving cavity, the outfeed section is arranged on a side of the recessed section away from the connecting section; and a diameter of the recessed section is smaller than each of a diameter of the connecting section and a diameter of the outfeed section, the recessed section is configured to abut against the reverse locking structure of the third thermal coupling section.

16. The hotend of claim 1, wherein the hotend further comprises a throat part, the throat part is connected with and thermally coupled with the heating section, the heating section is between the throat part and the nozzle part, the transmission channel further extends through the throat part, the heating section, and the nozzle part in sequence, the transmission channel is divided into a first sub-channel, a second sub-channel, and a third sub-channel connected in sequence, the first sub-channel is in the throat part, the second sub-channel is in the heating section, and the third sub-channel is in the nozzle part, the heat conduction part is in the second sub-channel.

17. The hotend of claim 16, wherein a diameter of the first sub-channel is smaller than a diameter of the second sub-channel at a junction of the throat part and the heating section; and a diameter of the second sub-channel is smaller than a diameter of the third sub-channel at a junction of the heating section and the nozzle part.

18. The hotend of claim 16, wherein the second sub-channel is divided into a buffer region and a functional region in communication with the buffer region, the buffer region is in communication with the first sub-channel and spaced apart from the third sub-channel, the functional region is in communication with the third sub-channel and spaced apart from the first sub-channel, the heat conduction part is in the functional region.

19. A head set, comprising an extrusion assembly and the hotend of claim 1, the hotend is connected to the extrusion assembly.

20. A 3D printing device, comprising a device body, a forming platform, and the head set of claim 19, the head set and the forming platform are respectively movably connected to the device body.
